(19) United States
(12) Patent Application Publication
(10) Pub. No.: US 2026/0367688 A1
(43) Pub. Date: Nov. 19, 2026

(54) DEVICE WAKEUP METHOD AND APPARATUS, ELECTRONIC DEVICE, AND STORAGE MEDIUM

(71) Applicant: Beijing Zitiao Network Technology Co., Ltd., Beijing (CN)

(72) Inventor: Dongpo LI, Beijing (CN)

(21) Appl. No.: 19/559,482

(22) Filed: Mar. 6, 2026

(30) Foreign Application Priority Data
May 19, 2025 (CN) 202510645612.4

(51) Int. Cl. G06F 1/3206; G10L 15/22

(52) U.S. Cl. CPC G06F 1/3206; G10L 15/22

(57) ABSTRACT

The present disclosure relates to a device wakeup method and apparatus, an electronic device, and a storage medium. The method is applicable to a target device, and the target device is any device in a target device cluster; the target device cluster includes at least two devices; and the at least two devices each may be woken up by using a same target wakeup word; and the method includes: determining whether a wakeup priority of the target device in the target device cluster is a highest priority when the target wakeup word is detected; waking up the target device itself if the wakeup priority of the target device is the highest priority; determining whether an associated device is in a wakeup state if the wakeup priority of the target device is not the highest priority, where the associated device is a device in the target device cluster with a wakeup priority higher than that of the target device; and waking up the target device itself if no associated device is in the wakeup state.

### CROSS-REFERENCE TO RELATED APPLICATION

This application claims priority to China Patent Application No. 202510645612.4 filed on May 19, 2025, the disclosure of which is incorporated herein by reference in its entirety.

### TECHNICAL FIELD

The present disclosure relates to the technical field of electronic devices, and in particular, to a device wakeup method and apparatus, an electronic device, and a storage medium.

### BACKGROUND

With the continuous development and maturity of Internet technology and remote control technology, many electronic devices have had a voice wakeup function. Specifically, a user may wake up an electronic device by speaking a preset wakeup word.

### SUMMARY

In order to solve the above technical problems or at least partially solve the above technical problems, the present disclosure provides a device wakeup method and apparatus, an electronic device, and a storage medium.

In a first aspect, the present disclosure provides a device wakeup method, where the device wakeup method is applicable to a target device, and the target device is any device in a target device cluster; the target device cluster includes at least two devices; the at least two devices each may be woken up by using a same target wakeup word; and the device wakeup method includes:
determining whether a wakeup priority of the target device in the target device cluster is a highest priority when the target wakeup word is detected;
waking up the target device itself if the wakeup priority of the target device is the highest priority;
determining whether an associated device is in a wakeup state if the wakeup priority of the target device is not the highest priority, where the associated device is a device in the target device cluster with a wakeup priority higher than that of the target device; and
waking up the target device itself if no associated device is in the wakeup state.

In a second aspect, the present disclosure further provides a device wakeup apparatus, where the device wakeup apparatus is applicable to a target device, and the target device is any device in a target device cluster; the target device cluster includes at least two devices; the at least two devices each may be woken up by using a same target wakeup word; and the device wakeup apparatus includes:
a priority determination module, configured to determine whether a wakeup priority of the target device in the target device cluster is a highest priority when the target wakeup word is detected; and
a wakeup module, configured to wake up the target device itself if the wakeup priority of the target device is the highest priority; determine whether an associated device is in a wakeup state if the wakeup priority of the target device is not the highest priority, where the associated device is a device in the target device cluster with a wakeup priority higher than that of the target device; and wake up the target device itself if no associated device is in the wakeup state.

In a third aspect, the present disclosure further provides an electronic device, including:
one or more processors;
a storage apparatus, configured to store one or more programs, where
the one or more programs, when executed by the one or more processors, cause the one or more processors to implement the device wakeup method according to the above first aspect.

In a fourth aspect, the present disclosure further provides a computer-readable storage medium, on which a computer program is stored, where the computer program, when executed by a processor, causes the device wakeup method according to the above first aspect to be implemented.

### BRIEF DESCRIPTION OF THE DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the related art, the following will briefly introduce the drawings that need to be used in the description of the embodiments or the related art. Obviously, for those of ordinary skill in the art, other drawings may be obtained according to these drawings without paying creative efforts.

FIG. 1 is a flowchart of a device wakeup method provided by an embodiment of the present disclosure;

FIG. 2 is a schematic structural diagram of a device wakeup apparatus provided by an embodiment of the present disclosure; and

FIG. 3 is a schematic structural diagram of an electronic device provided by an embodiment of the present disclosure.

### DETAILED DESCRIPTION OF EMBODIMENTS

In order to understand the above objectives, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein; obviously, the embodiments in the specification are part of the embodiments of the present disclosure, but not all of the embodiments.

In the related art, in a scenario where multiple devices are bound to the same account and are close in spatial distance, speaking the wakeup word by the user may cause multiple devices to be woken up simultaneously. This phenomenon not only interferes with subsequent voice operation of the user, but also causes unnecessary consumption of network bandwidth, computing resources, and power resources, further reducing the user's control experience.

FIG. 1 is a flowchart of a device wakeup method provided by an embodiment of the present disclosure, and the device wakeup method is applicable to a target device, where the target device is any device in a target device cluster; the target device cluster includes at least two devices; and the at least two devices each may be woken up by using a same target wakeup word.

Specifically, when multiple devices are configured to be woken up by using a same wakeup word, these devices together form a target device cluster. The wakeup word that may wake up all devices in the target device cluster is a target wakeup word of the target device cluster. Any device in the target device cluster may be used as the target device, and the device performs the device wakeup method according to the present application.

It should be further noted that multiple wakeup words may be set for the devices in the target device cluster, and the wakeup words of different devices may be not exactly the same. For example, it is assumed that there are a device A and a device B. Wakeup words that may be used to wake up the device A include a wakeup word a and a wakeup word b, and wakeup words that may be used to wake up the device B include the wakeup word b and a wakeup word c. Since both the device A and the device B may be woken up by the wakeup word b, the device A and the device B may form a target device cluster, and the wakeup word b is a target wakeup word of the target device cluster.

Any device in the target device cluster may be specifically a smartphone, a palmtop computer, a tablet computer, a wearable device with a display screen, a desktop computer, a laptop computer, an all-in-one machine, a smart home device, etc.

In the present application, “wakeup” refers to a process of activating a device in a standby, sleep, or other low-power consumption state to make it enter a normal working state; and it may also refer to activating a device that is not in a specific working mode to make it enter the specific working mode, for example, making an application installed on the device enter a normal working mode.

As shown in FIG. 1, the method may specifically include the following steps.

S110: determining whether a wakeup priority of the target device in the target device cluster is a highest priority when the target wakeup word is detected.

Exemplarily, a user speaks the target wakeup word to form an audio signal including the target wakeup word. The target device collects an audio signal around the target device, and parses the collected audio signal. If a parsing result reflects that certain audio information includes the target wakeup word, it is considered that the target wakeup word is detected.

Each device in the target device cluster is provided with a wakeup priority, and the wakeup priority is pre-configured before this step, and is used to control a sequence of wakeup judgment of each device. Specifically, a device with a higher wakeup priority preferentially performs the judgment of “whether to wake up itself”, while a device with a lower wakeup priority needs to wait for a device with a higher wakeup priority than the device to complete the judgment, and then performs the judgment of “whether to wake up itself” in combination with a final wakeup result of the device with the higher wakeup priority.

S120: waking up the target device itself if the wakeup priority of the target device is the highest priority.

The wakeup priority of the target device being the highest priority means that in the target device cluster, the target device is the first device to perform the judgment of “whether to wake up itself”.

In this step, waking up the target device itself specifically may include: determining a wakeup condition of the target device; waking up the target device itself if the wakeup condition of the target device is met; and giving up waking up the target device itself if the wakeup condition of the target device is not met.

The wakeup condition may include, for example, a condition related to an acoustic feature or a condition related to an environment where the device is located.

The condition related to the acoustic feature, for example, may refer to a condition related to a physical characteristic of sound. The physical characteristic of the sound may include at least one of the following: sound intensity, frequency, timbre, tone, and duration. For example, the wakeup condition is that the sound intensity of the audio signal including the target wakeup word is greater than a set intensity threshold. The condition related to the environment where the device is located, for example, may be to limit that the device may be allowed to wake up itself when the device is in a specific period of time or in a specific spatial environment. Setting the wakeup condition may avoid waking up the device at an inappropriate time or in an inappropriate scenario.

S130: determining whether an associated device is in a wakeup state if the wakeup priority of the target device is not the highest priority, where the associated device is a device in the target device cluster with a wakeup priority higher than that of the target device.

There are multiple implementation methods for this step, which is not limited in the present application. Exemplarily, the implementation method of this step may include: if the wakeup priority of the target device is not the highest priority, receiving current state information sent by the associated device within a preset waiting duration, where the current state information is used to prompt whether a sending device of the current state information is in the wakeup state; and determining whether the associated device is in the wakeup state based on the current state information of the associated device.

The preset waiting duration, for example, may be a parameter related to the wakeup priority of the device, and it is also pre-configured before S110. In practice, it may be set that the higher the wakeup priority of the target device, the shorter the preset waiting duration of the target device. In some scenarios, if a device has the highest wakeup priority, it may be considered that the preset waiting duration of the device is 0, so as to ensure that the device is the first device to perform the judgment of “whether to wake up itself”.

Based on this, optionally, before S110, the wakeup priority of the target device and the preset waiting duration corresponding to the target device are configured, where the higher the wakeup priority of the target device, the shorter the preset waiting duration of the target device.

It should be noted that, in some application scenarios, one device may be selected in the target device cluster, the wakeup priorities of all devices in the cluster and the preset waiting duration corresponding to each device are centrally configured in the selected device, and then the configuration result is synchronized to other devices in the target device cluster other than the selected device. In some other application scenarios, the wakeup priority and the preset waiting duration of a device may be configured on each device in the target device cluster, while ensuring that any two devices have different wakeup priorities and different preset waiting duration.

In some scenarios, after performing the judgment of “whether to wake up itself”, the associated device wakes up itself or gives up waking up itself according to the judgment result. No matter what operation (waking up itself or giving up waking up itself) is finally performed by the associated device, the associated device generates the current state information of the associated device, and sends the current state information of the associated device. It should be emphasized that even if the associated device performs the operation of waking up itself, in practice, due to the constraint of the wakeup condition, the result of successful wakeup or the result of failed wakeup may occur.

In some application scenarios, the sending, by the associated device, the current state information of the associated device specifically may include: the associated device periodically sends the current state information of the associated device in a broadcast manner.

If a device sends the current state information to other devices in the target device cluster to which the device belongs in a one-to-one or one-to-many manner, it is necessary to first determine which device or devices to use as the receiving object of the current state information. Obviously, this sending manner of the current state information is relatively complicated. By setting the device to send the current state information in the broadcast manner, the sending manner is relatively simple and easy to implement.

It should also be noted that, in the related art, when the user speaks the wakeup word, if multiple devices are woken up, it is often because these devices are physically close to the user, that is, the devices being woken up is strongly correlated with their physical distance from the user. In other words, the device that is accidentally woken up is often close in distance to the device that the user wants to be woken up, and may be considered as being in a same specific area. If a one-to-one or one-to-many communication manner is used to synchronize the current state information of the device, there may be a case that the determined receiving object of the current state information is far away from the user. In some cases, the user may not need to operate the device that is far away from the user. Therefore, whether the device far away from the user is woken up does not need to be considered. In view of this, using the broadcast manner to send the current state information may limit a receiving range of the current state information to a specific physical area, so that a device located in the specific physical area may receive the current state information sent by other devices in the same specific physical area, which may avoid sending redundant data to irrelevant devices.

S140: waking up the target device itself if no associated device is in the wakeup state.

If the wakeup priority of the target device is not the highest priority, it means that in the target device cluster, there is one or more devices with a wakeup priority higher than that of the target device. In other words, the number of associated devices corresponding to the target device is one or more.

In some scenarios, if the current state information is sent in the form of broadcast, in practice, through S130, within the preset waiting duration of the target device, the current state information sent by only some associated devices may be received, the current state information sent by all associated devices may be received, or the current state information sent by any associated device may not be received. In either case, if the current state information sent by an associated device is not received, it may be considered that the associated device is far away from the user, and the associated device is not the device that the user wants to wake up, so whether the associated device is in the wakeup state is not considered.

In other words, in this step, it is only considered whether the associated device that has sent the current state information is in the wakeup state.

If the received current state information prompts that no associated device is in the wakeup state, for example, it may mean that none of the senders of the received current state information is in the wakeup state.

In this step, the target device itself is woken up by using the same specific operation method as “waking up the target device itself” in S120. Exemplarily, waking up the target device itself includes: determining a wakeup condition of the target device; waking up the target device itself if the wakeup condition of the target device is met; and giving up waking up the target device itself if the wakeup condition of the target device is not met.

Exemplarily, the target device cluster includes four devices, and the four devices are ranked in a descending order of wakeup priority, and the ranking result is a device 1, a device 2, a device 3, and a device 4. It is assumed that at a certain moment, the device 1, the device 3, and the device 4 are closer to the user, the user speaks a target wakeup word corresponding to the target device cluster, and the device 1, the device 3, and the device 4 all may detect the target wakeup word. The device 1 performs an operation of whether to wake up itself. Whether the device 1 finally wakes up itself or not, the device 1 generates current state information of the device 1, and sends the current state information of the device 1 in the form of broadcast. The device 3 may receive the current state information of the device 1 within a preset waiting duration corresponding to the device 3, but cannot receive current state information of the device 2 (because the device 2 is far away from the user, the state of the device 2 is not considered). If it is determined, by analyzing the current state information of the device 1, that the device 1 is in a wakeup state, the device 3 does not wake up the device 3 itself. If it is determined, by analyzing the current state information of the device 1, that the device 1 is in a non-wakeup state, the device 3 wakes up the device 3 itself. Whether the device 3 finally wakes up itself or not, the device 3 generates current state information of the device 3, and sends the current state information of the device 3 in the form of broadcast. The device 4 may receive the current state information of the device 1 and the current state information of the device 3 within a preset waiting duration corresponding to the device 4, but cannot receive the current state information of the device 2. If it is determined, by analyzing the current state information of the device 1 and the current state information of the device 3, that the device 1 or the device 3 is prompted to be in the wakeup state, the device 4 does not wake up the device 4 itself. If it is determined, by analyzing the current state information of the device 1 and the current state information of the device 3, that the device 1 and the device 3 are prompted to be in the non-wakeup state, the device 4 wakes up the device 4 itself.

According to the above technical solution, it is determined whether a wakeup priority of a target device in a target device cluster is a highest priority when a target wakeup word is detected; the target device itself is woken up if the wakeup priority of the target device is the highest priority; it is determined whether an associated device is in a wakeup state if the wakeup priority of the target device is not the highest priority, where the associated device is a device in the target device cluster with a wakeup priority higher than that of the target device; and the target device itself is woken up if no associated device is in the wakeup state. Its essence is to use the wakeup priority to set a wakeup sequence for each device in the same target device cluster, and enable each device to sequentially perform the judgment of whether to wake up itself according to the wakeup sequence after the user speaks the target wakeup word, which may avoid the occurrence of a bad phenomenon that multiple devices are woken up at the same time after the user speaks the target wakeup word, thereby avoiding interference with subsequent voice operation of the user, avoiding unnecessary consumption of network bandwidth, computing resources and power resources, and improving the user's control experience.

In the case that a device may be woken up by multiple wakeup words, optionally, it may be set that the current state information sent by the associated device includes a wakeup word used to wake up the associated device; and the method further includes: determining whether the wakeup word used to wake up the associated device is consistent with the target wakeup word if there is the associated device in the wakeup state; giving up waking up the target device itself if the wakeup word used to wake up the associated device is consistent with the target wakeup word; and waking up the target device itself if the wakeup word used to wake up the associated device is not consistent with the target wakeup word.

Exemplarily, if the target device cluster includes two devices, the two devices are ranked in a descending order of wakeup priority, and the ranking result is a device A and a device B. The device A may be woken up by a wakeup word 1 and a wakeup word 2, and the device B may be woken up by the wakeup word 2, or the device B may be woken up by the wakeup word 1 and the wakeup word 2. If the user wakes up the device A by using the wakeup word 1, the device A is in the wakeup state, and the device B is in the non-wakeup state. When the user then speaks the wakeup word 2 (that is, the target wakeup word), the current state information sent by the device A prompts that the device A is in the wakeup state, and since the device A is woken up based on the wakeup word 1, the current state information sent by the device A includes the wakeup word 1. After the user speaks the wakeup word B, since the wakeup word (that is, the wakeup word 1) used to wake up the device A is not consistent with the target wakeup word (that is, the wakeup word 2), the device B wakes up itself.

By setting to give up waking up the target device itself if the wakeup word used to wake up the associated device is consistent with the target wakeup word, and wake up the target device itself if the wakeup word used to wake up the associated device is not consistent with the target wakeup word, the purpose is to allow the user to configure multiple wakeup words for the devices in the target device cluster, so as to meet the user's need to wake up another device in the target device cluster by speaking the target wakeup word on the basis that one device in the target device cluster has been woken up.

Based on the above technical solution, optionally, the devices in the same target device cluster are all bound to a same account; the current state information includes identification information of the account bound to the device that sends the current state information; and the receiving, within the preset waiting duration, the current state information sent by the associated device includes: receiving, within the preset waiting duration, current state information broadcast by a first device, where the first device is a device other than the target device; and determining that the first device is the associated device and the current state information sent by the first device is the current state information sent by the associated device if account identification information in the current state information broadcast by the first device is consistent with identification information of the account bound to the target device.

In practice, by setting that the devices in the target device cluster are all bound to the same account, and the devices in different device clusters are bound to different accounts, any device in the target device cluster may determine whether a certain device and the device itself belong to a same device cluster by determining whether identification information of an account bound to the certain device is consistent with identification information of an account bound to the device itself.

When the device uses the broadcast manner to send its current state information to the outside, the target device may receive the current state information sent by a device that belongs to a different device cluster from the target device. If the sender of the current state information and the target device belong to different device clusters, it means that the current state information has no impact on the judgment of whether the target device wakes up itself. By setting to receive the current state information broadcast by the first device within the preset waiting duration, where the first device is a device other than the target device; and determine that the first device is the associated device and the current state information sent by the first device is the current state information sent by the associated device if the account identification information in the current state information broadcast by the first device is consistent with the identification information of the account bound to the target device. In essence, the account identification information in the current state information is used to determine whether the first device is the associated device corresponding to the target device. If the first device is the associated device corresponding to the target device, whether the first device is in the wakeup state is considered when determining whether the target device wakes up itself. If the first device is not the associated device corresponding to the target device, whether the first device is in the wakeup state is not considered when determining whether the target device wakes up itself. This may avoid the interference of useless current state information on the judgment of whether the target device wakes up itself, thereby making the judgment result of whether the target device wakes up itself more accurate.

Based on the above technical solution, optionally, the method further may include: generating current state information of the target device if the wakeup priority of the target device in the target device cluster is not the lowest priority; and periodically broadcasting the current state information of the target device. This may ensure that a device in the target device cluster with a wakeup priority lower than that of the target device may accurately determine whether to wake up itself.

It should be noted that, for the sake of simple description, the foregoing method embodiments are all expressed as a series of action combinations, but those skilled in the art should know that the present application is not limited by the described action order, because according to the present application, some steps may be performed in other order or simultaneously. Secondly, those skilled in the art should also know that the embodiments described in the specification all belong to preferred embodiments, and the actions and modules involved are not necessarily required by the present application.

Compared with the related art, the technical solution provided by the embodiments of the present disclosure has the following advantages.

The device wakeup method in the technical solution provided by the embodiments of the present disclosure is applicable to a target device, and the target device is any device in a target device cluster; the target device cluster includes at least two devices; the at least two devices each may be woken up by using a same target wakeup word; it is determined whether a wakeup priority of the target device in the target device cluster is a highest priority when the target wakeup word is detected; the target device itself is woken up if the wakeup priority of the target device is the highest priority; it is determined whether an associated device is in a wakeup state if the wakeup priority of the target device is not the highest priority, where the associated device is a device in the target device cluster with a wakeup priority higher than that of the target device; and the target device itself is woken up if no associated device is in the wakeup state. Its essence is to use the wakeup priority to set a wakeup sequence for each device in the same target device cluster, and enable each device to sequentially perform the judgment of whether to wake up itself according to the wakeup sequence after the user speaks the target wakeup word, which may avoid the occurrence of a bad phenomenon that multiple devices are woken up at the same time after the user speaks the target wakeup word, thereby avoiding interference with subsequent voice operation of the user, avoiding unnecessary consumption of network bandwidth, computing resources and power resources, and improving the user's control experience.

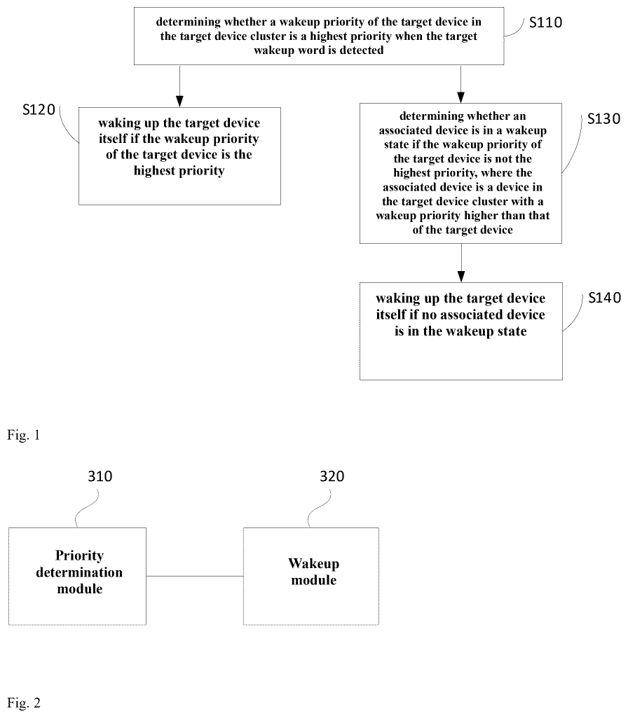

FIG. 2 is a schematic structural diagram of a device wakeup apparatus according to an embodiment of the present disclosure. The device wakeup apparatus is applicable to a target device, and the target device is any device in a target device cluster; the target device cluster includes at least two devices; and the at least two devices each may be woken up by using a same target wakeup word. Referring to FIG. 2, the device wakeup apparatus specifically includes:
a priority determination module 310, configured to determine whether a wakeup priority of the target device in the target device cluster is a highest priority when the target wakeup word is detected; and
a wakeup module 320, configured to wake up the target device itself if the wakeup priority of the target device is the highest priority; determine whether an associated device is in a wakeup state if the wakeup priority of the target device is not the highest priority, where the associated device is a device in the target device cluster with a wakeup priority higher than that of the target device; and wake up the target device itself if no associated device is in the wakeup state.

Further, the wakeup module 320 is configured to: if the wakeup priority of the target device is not the highest priority, receive current state information sent by the associated device within a preset waiting duration, where the current state information is used to prompt whether a sending device of the current state information is in the wakeup state; and
determine whether the associated device is in the wakeup state based on the current state information of the associated device.

Further, the apparatus further includes a configuration module, configured to configure the wakeup priority of the target device and the preset waiting duration corresponding to the target device before it is determined whether the wakeup priority of the target device in the target device cluster is the highest priority when the target wakeup word is detected, where the higher the wakeup priority of the target device, the shorter the preset waiting duration of the target device.

Further, the current state information sent by the associated device includes a wakeup word used to wake up the associated device, and the wakeup module 320 is configured to:
determine whether the wakeup word used to wake up the associated device is consistent with the target wakeup word if there is the associated device in the wakeup state;
give up waking up the target device itself if the wakeup word used to wake up the associated device is consistent with the target wakeup word; and
wake up the target device itself if the wakeup word used to wake up the associated device is not consistent with the target wakeup word.

Further, the devices in the same target device cluster are all bound to a same account; the current state information includes identification information of the account bound to the device that sends the current state information; and the wakeup module 320 is configured to:
receive current state information broadcast by a first device within the preset waiting duration, where the first device is a device other than the target device; and
determine that the first device is the associated device and the current state information sent by the first device is the current state information sent by the associated device if account identification information in the current state information broadcast by the first device is consistent with identification information of the account bound to the target device.

Further, the wakeup module 320 is configured to:
determine a wakeup condition of the target device; and
wake up the target device itself if the wakeup condition of the target device is met.

Further, the apparatus further includes a broadcast module, configured to:
generate current state information of the target device if the wakeup priority of the target device in the target device cluster is not the lowest priority; and
periodically broadcast the current state information of the target device.

The device wakeup apparatus provided by the embodiments of the present disclosure may perform the steps performed by the client or the server in the device wakeup method provided by the method embodiments of the present disclosure, and has the steps performed and beneficial effects, which will not be repeated herein.

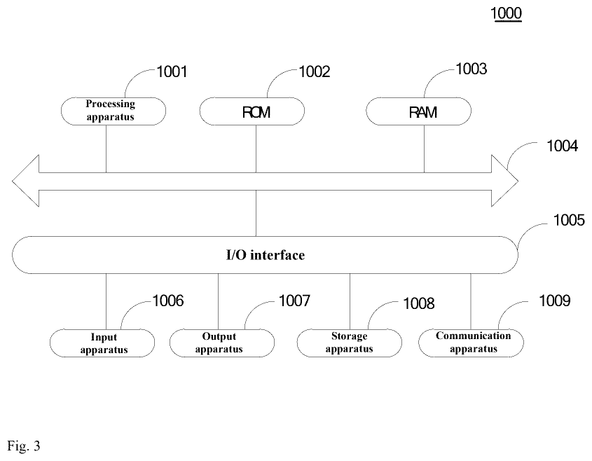

The following specifically refers to FIG. 3, which illustrates a schematic structural diagram of an electronic device 1000 suitable for implementing the embodiments of the present disclosure. The electronic device 1000 in the embodiments of the present disclosure may include, but are not limited to, mobile terminals such as a mobile phone, a notebook computer, a digital broadcast receiver, a personal digital assistant (PDA), a tablet computer (PAD), a portable multimedia player (PMP), a vehicle-mounted terminal (e.g., a vehicle navigation terminal), a wearable electronic device, etc., and fixed terminals such as a digital TV, a desktop computer, a smart home device, etc. The electronic device shown in FIG. 3 is only an example, and should not impose any limitation on the functions and scope of use of the embodiments of the present disclosure.

As shown in FIG. 3, the electronic device 1000 may include a processing apparatus (e.g., a central processing unit, a graphics processor, etc.) 1001, which may perform various appropriate actions and processes according to a program stored in a read-only memory (ROM) 1002 or a program loaded from a storage apparatus 1008 into a random access memory (RAM) 1003 to implement the device wakeup method of the embodiments as described in the present disclosure. In the RAM 1003, various programs and information necessary for the operation of the electronic device 1000 are also stored. The processing apparatus 1001, the ROM 1002, and the RAM 1003 are connected to each other through a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; a storage apparatus 1008 including, for example, a magnetic tape, a hard disk, etc.; and a communication apparatus 1009. The communication apparatus 1009 may allow the electronic device 1000 to perform wireless or wired communication with a first device to exchange information. Although FIG. 3 shows the electronic device 1000 having various apparatuses, it should be understood that it is not required to implement or have all of the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart, thereby implementing the device wakeup method as described above. In such an embodiment, the computer program may be downloaded and installed from a network through the communication apparatus 1009, or installed from the storage apparatus 1008, or installed from the ROM 1002. When the computer program is executed by the processing apparatus 1001, the above-mentioned functions defined in the method of the embodiments of the present disclosure are executed.

It should be noted that the above computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus or device. In the present disclosure, a computer-readable signal medium may include an information signal propagated in a baseband or as a part of a carrier wave, and computer-readable program code is carried therein. This propagated information signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

In some implementations, the client and the server may communicate using any known or future developed network protocol, such as the HyperText Transfer Protocol (HTTP), and may be interconnected with any form or medium of digital information communication (for example, a communication network). Examples of the communication network include a local area network (“LAN”), a wide area network (“WAN”), an internet (for example, the Internet), a peer-to-peer network (for example, an Ad-Hoc network), and any network known or to be developed in the future.

The above computer-readable medium may be included in the above electronic device, or it may exist alone without being assembled into the electronic device.

The above computer-readable medium carries one or more programs, which, when executed by the electronic device, cause the electronic device to:
determine whether a wakeup priority of the target device in the target device cluster is a highest priority when the target wakeup word is detected;
wake up the target device itself if the wakeup priority of the target device is the highest priority;
determine whether an associated device is in a wakeup state if the wakeup priority of the target device is not the highest priority, where the associated device is a device in the target device cluster with a wakeup priority higher than that of the target device; and
wake up the target device itself if no associated device is in the wakeup state.

Optionally, when the one or more programs are executed by the electronic device, the electronic device may further perform the other steps described in the above embodiments.

The computer program code for performing the operations of the present disclosure may be written in one or more programming languages or a combination thereof, where the above programming languages include but are not limited to object-oriented programming languages such as Java, Smalltalk, C++, and include conventional procedural programming languages such as “C” language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (LAN) or a wide area network (WAN), or it may be connected to an external computer (for example, connected through Internet provided by an Internet service provider).

The flowchart and block diagrams in the drawings illustrate the possibly implemented architectures, functions, and operations of the system, the method, and the computer program product according to various embodiments of the present disclosure. In this regard, each block in the flowchart or block diagram may represent a module, a program segment, or a part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, and may also be implemented by means of hardware. The name of a unit does not constitute a limitation on the unit itself under certain circumstances.

The functions described herein above may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium includes, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, the present disclosure provides an electronic device, including:
one or more processors;
a memory, configured to store one or more programs, where
the one or more programs, when executed by the one or more processors, cause the one or more processors to implement the device wakeup method according to any one provided in the present disclosure.

According to one or more embodiments of the present disclosure, the present disclosure provides a computer-readable storage medium, on which a computer program is stored, where the computer program, when executed by a processor, causes the device wakeup method according to any one provided in the present disclosure to be implemented.

An embodiment of the present disclosure further provides a computer program product, which includes a computer program or instructions, where the computer program or instructions, when executed by a processor, cause the device wakeup method as described above to be implemented.

It should be noted that in this paper, relational terms such as “first” and “second” are only used to distinguish one entity or operation from another entity or operation, and do not necessarily require or imply any actual relationship or order between these entities or operations. Moreover, the terms “include”, “comprise” or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by the phrase “including a” does not exclude that there are other identical elements in the process, method, object or device including the element.

The above descriptions are only specific embodiments of the present disclosure, so that those skilled in the art may understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

We claim:

1. A device wakeup method, wherein the device wakeup method is applicable to a first device, and the first device is any device in a device cluster; the device cluster comprises at least two devices; the at least two devices each are wakeable by using a same wakeup word; and the device wakeup method comprises:
obtaining a wakeup priority of the first device in the device cluster in response that the target wakeup word is detected; and
waking up the first device itself in response that the wakeup priority of the first device is the highest priority.

2. The method of claim 1, wherein the method further comprises:
obtaining a wakeup state of an associated device in response that the wakeup priority of the first device is not the highest priority, wherein the associated device is a device in the device cluster with a wakeup priority higher than that of the first device; and
waking up the first device itself in response that no associated device is in the wakeup state.

3. The method of claim 2, wherein the obtaining a wakeup priority of the first device in the device cluster in response that the target wakeup word is detected comprises:
in response that the wakeup priority of the first device is not the highest priority, receiving current state information sent by the associated device within a preset waiting duration, wherein the current state information is used to indicate whether a sending device of the current state information is in the wakeup state; and
obtaining the wakeup state of the associated device based on the current state information of the associated device.

4. The method of claim 3, wherein before the obtaining a wakeup priority of the first device in the device cluster in response that the target wakeup word is detected, the method further comprises:
configuring the wakeup priority of the first device and the preset waiting duration corresponding to the first device, wherein a higher the wakeup priority of the first device is, a shorter the preset waiting duration of the first device is.

5. The method of claim 3, wherein the current state information sent by the associated device comprises a wakeup word used to wake up the associated device, and the method further comprises:
in response to there being the associated device in the wakeup state, obtaining the wakeup word used to wake up the associated device;
in response to the wakeup word used to wake up the associated device being consistent with the target wakeup word, giving up waking up the first device itself; and
in response to the wakeup word used to wake up the associated device being not consistent with the target wakeup word, waking up the first device itself.

6. The method of claim 3, wherein devices in a same device cluster each are bound to a same account; the current state information comprises identification information of an account bound to a device that sends the current state information; and the receiving the current state information sent by the associated device within the preset waiting duration comprises:
receiving current state information broadcast by a first device within the preset waiting duration, wherein the first device is a device other than the first device; and
in response to account identification information in the current state information broadcast by the first device being consistent with identification information of the account bound to the first device, determining that the first device is the associated device, and the current state information sent by the first device is the current state information sent by the associated device.

7. The method of claim 1, wherein the waking up the first device itself comprises:
obtaining a wakeup condition of the first device; and
in response to the wakeup condition of the first device being met, waking up the first device itself.

8. The method of claim 1, further comprising:
in response to the wakeup priority of the first device in the device cluster not being a lowest priority, generating current state information of the first device; and
periodically broadcasting the current state information of the first device.

9. An electronic device, comprising:
one or more processors; and
a storage apparatus, configured to store one or more programs, wherein
the one or more programs, when executed by the one or more processors, cause the one or more processors to implement a device wakeup method, wherein the device wakeup method is applicable to a first device, and the first device is any device in a device cluster; the device cluster comprises at least two devices; the at least two devices each are wakeable by using a same target wakeup word; and the device wakeup method comprises:
obtaining a wakeup priority of the first device in the device cluster in response that the target wakeup word is detected; and
waking up the first device itself in response that the wakeup priority of the first device is the highest priority.

10. The electronic device of claim 9, wherein the method further comprises:
obtaining a wakeup state of an associated device in response that the wakeup priority of the first device is not the highest priority, wherein the associated device is a device in the device cluster with a wakeup priority higher than that of the first device; and
waking up the first device itself in response that no associated device is in the wakeup state.

11. The electronic device of claim 10, wherein the obtaining a wakeup priority of the first device in the device cluster in response that the target wakeup word is detected comprises:
in response that the wakeup priority of the first device is not the highest priority, receiving current state information sent by the associated device within a preset waiting duration, wherein the current state information is used to indicate whether a sending device of the current state information is in the wakeup state; and
obtaining the wakeup state of the associated device based on the current state information of the associated device.

12. The electronic device of claim 11, wherein before the obtaining a wakeup priority of the first device in the device cluster in response that the target wakeup word is detected, the method further comprises:
configuring the wakeup priority of the first device and the preset waiting duration corresponding to the first device, wherein a higher the wakeup priority of the first device is, a shorter the preset waiting duration of the first device is.

13. The electronic device of claim 11, wherein the current state information sent by the associated device comprises a wakeup word used to wake up the associated device, and the method further comprises:
in response to there being the associated device in the wakeup state, obtaining the wakeup word used to wake up the associated device;
in response to the wakeup word used to wake up the associated device being consistent with the target wakeup word, giving up waking up the first device itself; and
in response to the wakeup word used to wake up the associated device being not consistent with the target wakeup word, waking up the first device itself.

14. The electronic device of claim 11, wherein devices in a same device cluster each are bound to a same account; the current state information comprises identification information of an account bound to a device that sends the current state information; and the receiving the current state information sent by the associated device within the preset waiting duration comprises:
receiving current state information broadcast by a first device within the preset waiting duration, wherein the first device is a device other than the first device; and
in response to account identification information in the current state information broadcast by the first device being consistent with identification information of the account bound to the first device, determining that the first device is the associated device, and the current state information sent by the first device is the current state information sent by the associated device.

15. A non-transitory computer-readable storage medium, on which a computer program is stored, wherein the computer program, when executed by a processor, causes a device wakeup method to be implemented, wherein the device wakeup method is applicable to a first device, and the first device is any device in a device cluster; the device cluster comprises at least two devices; the at least two devices each are wakeable by using a same target wakeup word; and the device wakeup method comprises:
obtaining a wakeup priority of the first device in the device cluster in response that the target wakeup word is detected; and
waking up the first device itself in response that the wakeup priority of the first device is the highest priority.

16. The non-transitory computer-readable storage medium of claim 15, wherein the method further comprises:
obtaining a wakeup state of an associated device in response that the wakeup priority of the first device is not the highest priority, wherein the associated device is a device in the device cluster with a wakeup priority higher than that of the first device; and
waking up the first device itself in response that no associated device is in the wakeup state.

17. The non-transitory computer-readable storage medium of claim 16, wherein the obtaining a wakeup priority of the first device in the device cluster in response that the target wakeup word is detected comprises:
in response that the wakeup priority of the first device is not the highest priority, receiving current state information sent by the associated device within a preset waiting duration, wherein the current state information is used to indicate whether a sending device of the current state information is in the wakeup state; and
obtaining the wakeup state of the associated device based on the current state information of the associated device.

18. The non-transitory computer-readable storage medium of claim 17, wherein before the obtaining a wakeup priority of the first device in the device cluster in response that the target wakeup word is detected, the method further comprises:
configuring the wakeup priority of the first device and the preset waiting duration corresponding to the first device, wherein a higher the wakeup priority of the first device is, a shorter the preset waiting duration of the first device is.

19. The non-transitory computer-readable storage medium of claim 17, wherein the current state information sent by the associated device comprises a wakeup word used to wake up the associated device, and the method further comprises:
in response to there being the associated device in the wakeup state, obtaining the wakeup word used to wake up the associated device;
in response to the wakeup word used to wake up the associated device being consistent with the target wakeup word, giving up waking up the first device itself; and
in response to the wakeup word used to wake up the associated device being not consistent with the target wakeup word, waking up the first device itself.

20. The non-transitory computer-readable storage medium of claim 17, wherein devices in a same device cluster each are bound to a same account; the current state information comprises identification information of an account bound to a device that sends the current state information; and the receiving the current state information sent by the associated device within the preset waiting duration comprises:
receiving current state information broadcast by a first device within the preset waiting duration, wherein the first device is a device other than the first device; and
in response to account identification information in the current state information broadcast by the first device being consistent with identification information of the account bound to the first device, determining that the first device is the associated device, and the current state information sent by the first device is the current state information sent by the associated device.
